(19) United States
(12) Patent Application Publication
(10) Pub. No.: US 2012/0017928 A1
(43) Pub. Date: Jan. 26, 2012

(54) APPARATUS AND METHOD FOR CUTTING HAIR

(76) Inventor: Raisa Raskin, Tempe, AZ (US)

(21) Appl. No.: 12/843,865

(22) Filed: Jul. 26, 2010

(51) Int. Cl. B26B 19/38

(52) U.S. Cl. 132/200; 30/34.05

(57) ABSTRACT

The invention discloses for one or more combs, where the spine thickness of a given comb is specifically matched to the thickness of a cutting blade for an electric clipper. In addition, a method of using the combs to make a smoother and more even transition from one hair length to another hair length in the hair-cutting process is disclosed.

### BACKGROUND OF THE INVENTION

1. Technical Field

The present invention generally relates to hair styling and relates more specifically to implements used in conjunction with electric clippers.

2. Background Art

Cutting hair is a skill and an art, much more than a science. Although the standard implements used in cutting hair are well known, it is the skill of the barber or the stylist that determines the quality of a haircut. It can take many years to learn how to cut hair and, in the early stages of a career, mistakes and bad haircuts are not uncommon.

Even with the most skilled stylists and barbers, it is possible to make a mistake in the haircutting process, thereby creating a “bad hair day” for the customer. One of the most common mistakes, especially when using electric hair clippers, is a tendency to cut a portion of the hair too short, thereby creating a need to “fix” the problem. This typically results in a haircut that is noticeably shorter than originally planned, if the problem can be fixed at all. Accordingly, most new graduates of hair styling and barber schools work for years trying to develop the necessary skills that are needed to be a successful stylist or barber.

In general, most haircutting professionals establish a “guide” length, which is the desired length that the customer specified for the hair on the sides & back of the head. For example, several of the most common blades that are used to achieve a desired length for many haircuts are the Oster® #1.5 blade (4.5 mm or 5/32″) and the Oster® #2 blade (6 mm or ¼″). The number of the blade correlates generally to the length that the hair should be cut to on the sides and back of the head. The desired length for the hair on the top of the head is generally specified by the customer in inches (e.g., ½″ or 1″). Given this, the art of the haircutting profession includes the ability to make the transition from length of the hair on the sides and back of the head (guide length) to the top length in a smooth and precise fashion.

For most barbers and hair stylists, this transition in the length of the hair is accomplished by using a standard comb in a “freestyle” manner. To make the transition, the barber or hairstylist will typically hold the comb in one hand and use the comb to lift the hair away from the head. Then, they will cut the hair with the other hand using an electric hair clipper with the selected blade attachment. In order to achieve a smooth transition between two different lengths of hair, the barber or stylist needs to hold the hand with the comb in the air without any support and estimate or “eye ball” the length of hair to be cut. In this stage of the haircut it is very easy to make a mistake and cut the hair too close to the scalp (i.e. shorter than the guide length). Once the hair is cut too short in one spot, it cannot be fixed except by cutting the hair shorter all around the head. This stage of the haircut requires very precise hand-eye coordination and can be a very challenging operation that requires high concentration and precision. Many barbers and hair stylists, both new and experienced, find it difficult to make the transition between the different lengths of hair, resulting in uneven and unprofessional haircuts. Accordingly, without improvements in the implements and methods of cutting hair, the process and results of many haircuts will continue to be sub-optimal.

### BRIEF SUMMARY OF THE INVENTION

A specialized set of combs, comprising a plurality of combs with varying spine thicknesses that are specifically calibrated to the thickness of the plate for an electric clipper blade is disclosed. In addition, a method of using the combs in the hair-cutting process is disclosed. By selecting a comb with a spine thickness that matches the blade plate, the desired hair length can be achieved with a reduced probability of accidentally cutting the hair too short.

### BRIEF DESCRIPTION OF THE FIGURES

The preferred embodiments of the present invention will hereinafter be described in conjunction with the appended drawings, wherein like designations denote like elements, and:

FIG. 1 illustrates a collection of prior art tools used for cutting hair;

FIG. 2 illustrates a pair of prior art removable clipper blades commonly used in conjunction with electric clippers when cutting hair;

FIG. 3 is a side view of the clipper blades of FIG. 2.

FIG. 4 illustrates a pair of combs in accordance with a preferred embodiment of the present invention.

FIG. 5 is a side view of the combs of FIG. 4.

FIG. 6 illustrates a method of using the combs of the present invention to provide a haircut to a customer in accordance with a preferred embodiment of the present invention.

### DETAILED DESCRIPTION

A specialized set of combs, comprising a plurality of combs with varying spine thicknesses that are specifically calibrated to the thickness of the plate for an electric clipper is disclosed. In addition, a method of using the combs in the hair-cutting process is disclosed. By selecting a comb with a spine thickness that matches the blade plate, the desired hair length can be achieved with a reduced probability of accidentally cutting the hair too short.

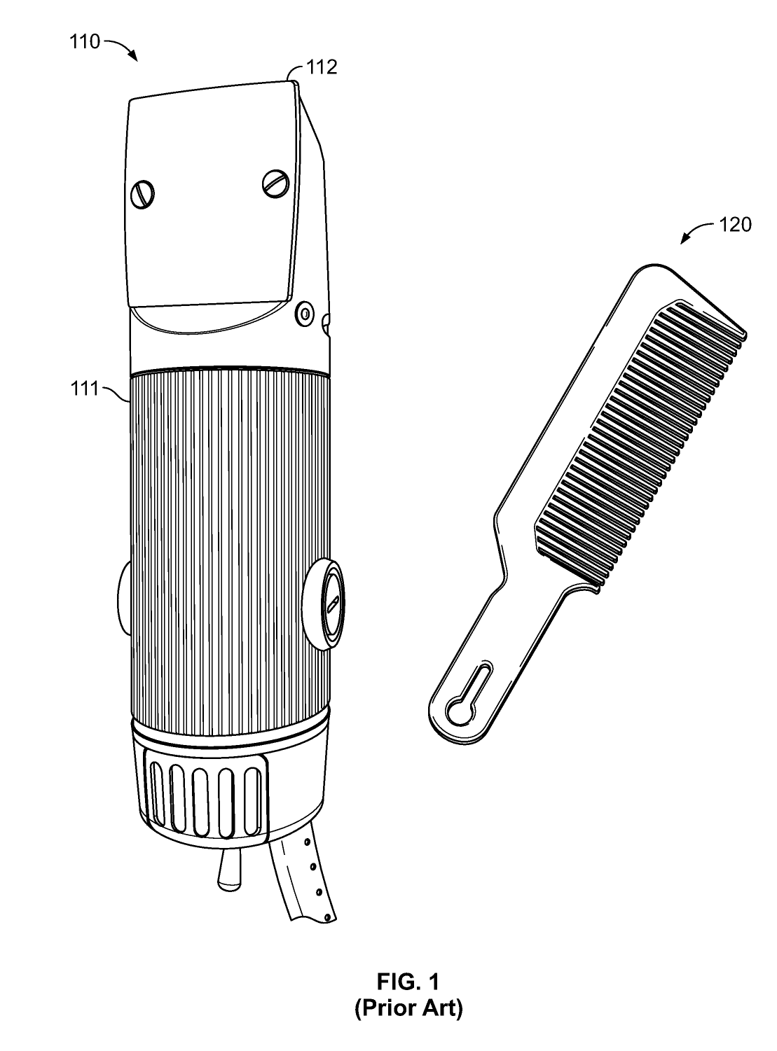

Referring now to FIG. 1, an electric clipper 110, along with a comb 120 are shown. Electric clipper 110 has a body portion 111 for holding electric clipper 110 and is configured with the capability to selectively detachable clipper blade at clipper head 112. Those skilled in the art will recognize that these items are commonly used implements when a hair stylist or a barber is cutting hair. Comb 120 is typically used by hair stylists and barbers to hold the hair of their customer away from the head during the haircutting process. The use of comb 120, in concert with electric clipper 110 is a skill that must be mastered in order to position comb 120 so as to prevent electric clipper 110 from cutting too much hair from the head of the customer.

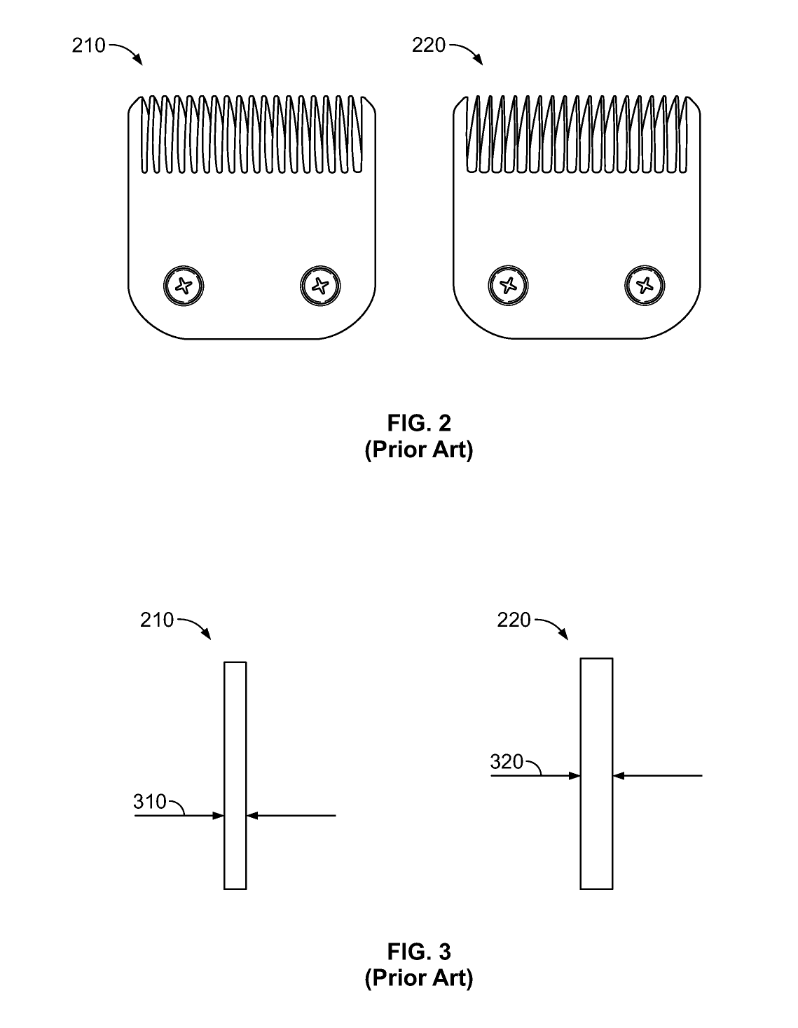

Referring now to FIG. 2, a prior art clipper blade 210 and a prior art clipper blade 220 are depicted. These clipper blades are representative of a series of clipper blades that may be attached to electric clipper 110 of FIG. 1. Those skilled in the art will recognize that these items are commonly used implements when a stylist or barber are cutting hair. In most cases, each clipper blade has a numeric indicia stamped or embossed into the body of the clipper blade. Different clipper blades are used to cut hair, with the appropriate clipper blade being selected based on the desired amount of hair to be cut and the desired length of the hair to remain after the haircut. In general, the smaller the number, the shorter the hair will be after the hair cut.

Referring now to FIG. 3, a side view of each of clipper blade 210 and clipper blade 220 of FIG. 2 is shown. As shown in FIG. 3, each of clipper blade 210 and clipper blade 220 has a clipper blade thickness 310 or a clipper blade thickness 320, respectively.

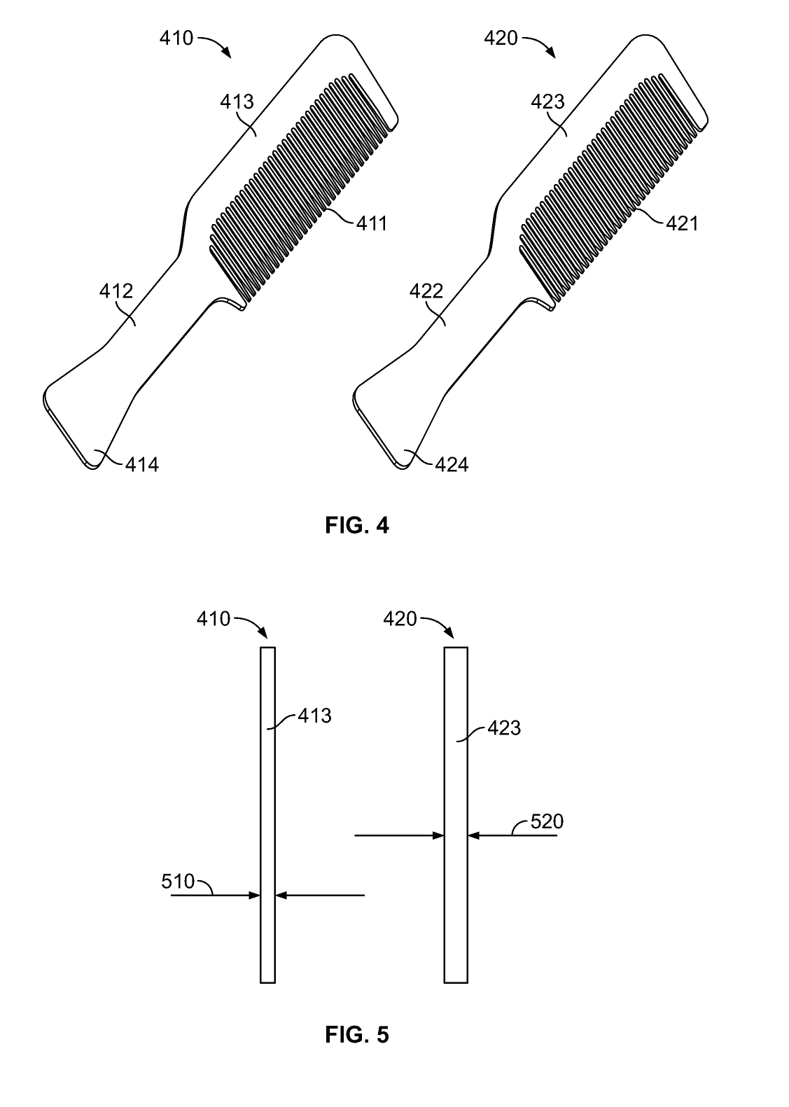

Referring now to FIG. 4, a pair of combs in accordance with a preferred embodiment of the present invention is shown. Comb 410 comprises a handle portion 412, a plurality of teeth 411, a spine portion 413, and a brace portion 414. Comb 420 comprises a handle portion 422, a plurality of teeth 421, a spine portion 423, and a “fish-tail” or brace portion 424.

Referring now to FIG. 5, a side view of each of comb 410 and comb 420 is shown. As shown in FIG. 5, each of comb 410 and comb 420 has a spine thickness 510 or a spine thickness 520, respectively. As shown in FIG. 5, spine thickness 520 is greater than spine thickness 510.

Referring now to FIG. 4 and FIG. 5, the unique characteristics of the combs of the present invention can be more fully understood. While comb 410 and comb 420 are similar in some respects to other combs, the spine thickness 510 of spine portion 413 and spine thickness 520 of spine portion 423 have been specifically selected so as to correlate with blade thickness 310 and blade thickness 320, respectively.

In the most preferred embodiments of the present invention, the spine thickness 510 of comb 410 will be substantially identical to the thickness 310 of cutting blade 210. Similarly, the spine thickness 520 of comb 420 will be substantially identical to the thickness 320 of cutting blade 220.

In certain preferred embodiments of the present invention, comb 410 and comb 420, as well as other combs with varying spine thicknesses to match the spine thickness of a variety of cutting blades, are combined together and may be sold as a unit, in a kit or other similar packaging arrangement. By selecting the appropriate comb, with a spine thickness that matches the thickness of the cutting blade, the hair stylists and barbers that are using comb 410 and comb 420 will automatically be using a comb that is designed to keep electric clippers closer to or further away from the head of the customer receiving the hair cut.

Brace portion 424 consists of an enlarged section of handle portion 412 and is specifically configured to provide the hair stylist or barber with additional leverage for holding and positioning comb 410 or comb 420.

Those skilled in the art will recognize that by varying the thickness of the spine portion of a comb, the hair stylist or barber will be better equipped to keep electric clipper 110 of FIG. 1 in the proper position, relative to the head of the customer receiving the haircut. This is true for beginners as well as experienced hair stylists and barbers alike. The various embodiments of the present invention will assist hair stylists and barbers with the process of cutting hair to the appropriate length and will help to reduce or eliminate the possibility of cutting the hair too short.

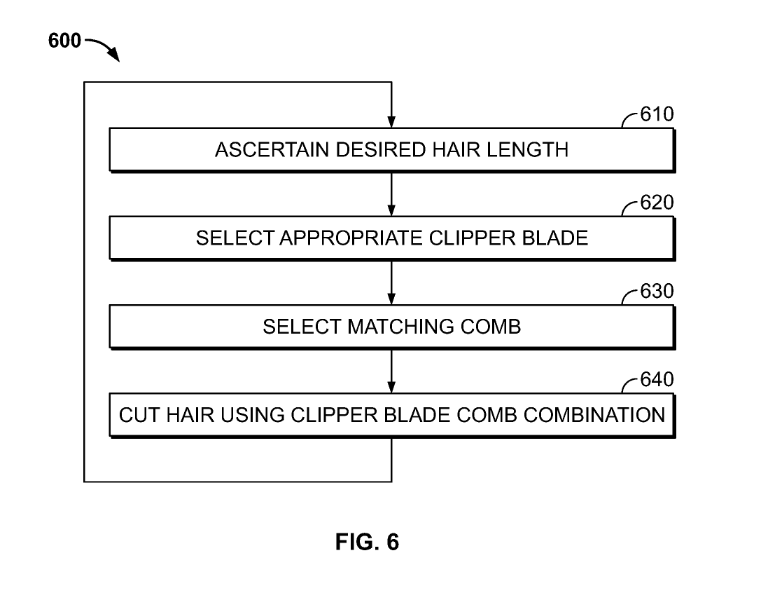

Referring now to FIG. 6, a method 600 for using one or more combs of the present invention in providing a haircut is illustrated. As shown in FIG. 6, the hair stylist or barber will first ascertain the desired hair length (step 610). Next, the hair stylist or barber will select the appropriate cutting blade to use in cutting the hair to the desired length (step 620). With the appropriate cutting blade selected, the hair stylist or barber will select the matching comb (e.g., the comb that has a spine thickness that is substantially similar to the thickness of the selected cutting blade) (step 630). Finally, the hair stylist or barber will cut the hair using the selected combination of comb and cutting blade (step 640).

It should also be noted that the hair stylist or barber may repeat the cycle with multiple matching combinations of cutting blades and combs for certain haircuts and other situations where the haircut involves cutting the hair in multiple different lengths. The process of selecting cutting blades and combs with matching thicknesses can be repeated as necessary until the haircut has been completed.

First the hair is cut on the sides & back of the head to the specified length using, for example, a #1.5 or #2 clipper blade, and on top of the head according to the guide length. In order to perform the above-described transition, a coordinating comb is chosen based on the requested length of the hair. Then, the comb is leaned with a slight pressure against the scalp and acts as a buffer between the hair and the blade. The hair is lifted with the comb in one hand and cut with the other hand, which is holding the electric clipper.

These combs offer a two-fold solution to the problem described above. First, because they have a spine thickness that corresponds to the size of the blade, the probability that the hair professional will cut more hair than desired is greatly reduced or eliminated. The thickness of the spine prevents the blade from going too far and cutting too much hair. Second, holding the comb while cutting the hair and leaning the comb gently against the customer's head provides significant hand support and greatly improves hand-eye coordination for both new and experienced barbers and hair stylists. The result is a new method of cutting hair and creating a smooth and mistake-free transition between two lengths of hair. The quality of the haircut, as well as barber's confidence and customer satisfaction, are greatly improved. Finally, the most preferred embodiments of the combs feature an ergonomically designed handle in the form of a “fish-tail” that ensures a firm grip on the handle and supports the palm of the hand. It fits well with any size hand, large or small.

While the examples set forth herein depict only a pair of combs, those skilled in the art will understand that is within the contemplated scope of this invention to include a plurality of combs (e.g., more than two), with the spine thickness of each of the combs corresponding to the thickness of a cutting blade. In this preferred embodiment of the present invention, no matter what cutting blade is selected, there will be a matching comb to be used with the selected cutting blade.

In another preferred embodiment of the present invention, an indicia representing the size of the cutting blade that corresponds to each of the combs is affixed to or printed on or embedded onto or into the handle of the appropriate comb. In this fashion, the hair stylist or barber can quickly and easily identify and select the appropriate comb, based on the selected cutting blade. In yet another preferred embodiment of the present invention, each matching set of comb and cutting blade may be provided with a color-based indicia or other similar marking. This will provide for the selection of a cutting blade and a corresponding comb by simply picking the matching colors.

In at least one preferred embodiment of the present invention, a set of two combs will be provided as a kit. The first comb will have a spine that is approximately 4.5 mm thick and the other comb will have a spine that is approximately 6 mm thick. These spine thicknesses corresponds to Oster® #1.5 clipper blade (4.5 mm or 5/32″) and Oster® #2 clipper blade (6 mm or ¼″) which are the most commonly used blades for shorter haircuts. The combs are used in performing the transition cut between two lengths of hair. The combs are a tool that enables the barber to avoid cutting the hair too short at the transition spot and provides additional hand support while cutting hair. These combs are especially useful for barbering or beauty students but also useful for experienced professionals.

From the foregoing description, it should be appreciated that an enhanced apparatus and methods for cutting hair is provided by the various preferred embodiments of the present invention and that the various preferred embodiments offer significant benefits that would be apparent to one skilled in the art. For example, those skilled in the art will understand that additional preferred embodiments of the combs and methods described herein could be readily adapted for use in pet grooming as well as other applications.

Furthermore, while multiple preferred embodiments have been presented in the foregoing description, it should be appreciated that a vast number of variations in the preferred embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

What is claimed is:

1. An apparatus comprising:
a first comb, said first comb comprising:
a first handle; and
a first spine portion, said first spine portion defining a first spine thickness;
a first clipper blade, said first clipper blade defining a first blade thickness wherein said first blade thickness is substantially equal to said first spine thickness.

2. The apparatus of claim 1 wherein said first blade thickness and said first spine thickness are substantially equal to 4.5 mm.

3. The apparatus of claim 1 wherein said first blade thickness and said first spine thickness are substantially equal to 6 mm.

4. The apparatus of claim 1 further comprising a plurality of teeth affixed to said handle.

5. The apparatus of claim 1 wherein said handle further comprises a fishtail portion.

6. The apparatus of claim 1 wherein said first clipper blade comprises at least one of an Oster® #1.5 clipper blade and an Oster® #2 clipper blade.

7. The apparatus of claim 1 further comprising:
a second comb, said second comb comprising:
a second handle; and
a second spine portion, said second spine portion defining a second spine thickness; and
a second clipper blade, said second clipper blade defining a second blade thickness wherein said second blade thickness is substantially equal to said second spine thickness.

8. The apparatus of claim 7 wherein said first clipper blade comprises an Oster® #1.5 clipper blade and said second clipper blade comprises an Oster® #2 clipper blade.

9. The apparatus of claim 7 wherein said first blade thickness and said first spine thickness are substantially equal to 4.5 mm and wherein said second blade thickness and said second spine thickness are substantially equal to 6 mm.

10. An apparatus comprising:
a first comb, said first comb comprising:
a handle portion, said handle portion comprising a fishtail portion;
a spine portion, said spine portion defining a first spine thickness, said first spine thickness corresponding to a first electric clipper blade thickness; and
a plurality of teeth affixed to said handle portion;
a second comb, said second comb comprising:
a handle portion, said handle portion comprising a fishtail portion;
a second spine portion, said second spine portion defining a second spine thickness, said second spine thickness corresponding to a second electric clipper blade thickness; and
a plurality of teeth affixed to said handle portion.

11. A method of cutting hair, the method comprising the steps of:
a) cutting a first portion of a client's hair to a first length;
b) cutting a second portion of a client's hair to a second length;
c) attaching a first clipper blade to an electric clipper, said first clipper blade comprising a plurality of cutting teeth and a first blade thickness;
d) selecting a first comb, said first comb comprising a plurality of teeth and a spine, said spine comprising a first spine thickness, wherein said first blade thickness and said first spine thickness are substantially identical; and
e) creating a transition between said first length and said second length using said electric clipper and said first comb.

12. The method of claim 11 wherein said first blade thickness and said first spine thickness are substantially equal to 4.5 mm.

13. The method of claim 11 wherein said first blade thickness and said first spine thickness are substantially equal to 6 mm.

14. The method of claim 11 wherein said first comb further comprises a fishtail portion.

15. The method of claim 11 wherein steps c) and d) are performed prior to steps a) and b).

16. The method of claim 11 wherein said first clipper blade comprises at least one of an Oster® #1.5 clipper blade and an Oster® #2 clipper blade.

17. The method of claim 11 further comprising the steps of:
f) attaching a second clipper blade to said electric clipper, said second clipper blade comprising a plurality of cutting teeth and a second blade thickness; and
g) selecting a second comb, said second comb comprising a plurality of teeth and a spine, said spine comprising a second spine thickness, wherein said second blade thickness and said second spine thickness are substantially identical.

18. The method of claim 17 wherein said first clipper blade comprises an Oster® #1.5 clipper blade and said second clipper blade comprises an Oster® #2 clipper blade.

19. The method of claim 17 wherein said second comb further comprises a fishtail portion.

20. The method of claim 17 wherein said first blade thickness and said first spine thickness are substantially equal to 4.5 mm and wherein said second blade thickness and said second spine thickness are substantially equal to 6 mm.
